(19) United States
(12) Patent Application Publication
(10) Pub. No.: US 2011/0246029 A1
(43) Pub. Date: Oct. 6, 2011

(54) METHOD OF TUNING ACTIVE SAFETY SYSTEMS FOR VEHICLES, SYSTEM OBTAINED BY SAID METHOD AND VEHICLE COMPRISING A SYSTEM OBTAINED BY SAID METHOD

(75) Inventors: Thierry Villemin, Dammartin en Goele (FR); Benoît Krol, Dammartin en Goele (FR); Philippe Delval, Berry Au Bac (FR)

(73) Assignee: ROBERT BOSCH GMBH, Stuttgart (DE)

(21) Appl. No.: 13/120,273

(22) PCT Filed: Aug. 20, 2009
(86) PCT No.: PCT/EP2009/060797

§ 371 Date: Jun. 6, 2011

(30) Foreign Application Priority Data
Sep. 22, 2008 (FR) 08/05199

(51) Int. Cl. B60R 21/00; G01M 17/007

(52) U.S. Cl. 701/45

(57) ABSTRACT

The present invention relates to a method of tuning an active safety system of a motor vehicle, notably an antilock braking system (ABS), an anti-skid system (ARS or TSC), a path control device (ESP), an overall motor vehicle chassis control system (VDM) or similar, and an active safety system obtained by said method and/or the motor vehicles equipped with such an active safety system.

The subject of the present invention is a method of tuning active safety systems employing a vehicle comprising at least one wheel equipped with a coating (1) with low tyre grip advantageously made of a plastic material with low friction coefficient, preferably of the polytetrafluoroethylene (PTFE) type or a mixture or an alloy of PTFE with other materials.

The present invention applies notably to the motor vehicle industry.

The present invention applies mainly to the active safety system industry.

### BACKGROUND OF THE INVENTION

The present invention relates to a method of tuning an active safety system of a motor vehicle, notably an antilock braking system (ABS), an anti-skid system (ARS or TSC), a path control device (ESP), an overall motor vehicle chassis control system (VDM) or similar, and an active safety system obtained by said method and/or the motor vehicles equipped with such an active safety system.

As is known, the behaviour of the vehicles depends on the tyre grip of the wheels on the rolling surface. This behaviour is notably degraded when said tyre grip diminishes, for example on wet ground, on wet grass, on oil puddles, on snow or on black ice. Thus, the motor vehicle manufacturers have been urged to equip the vehicles with active safety devices or systems referred to in the art by their English abbreviations ABS, ESP, ASR, ACC, VDM, at least partially compensating for the degradation of the behaviour of the vehicle rolling on a surface with low or very low tyre grip. Unfortunately, developing these systems demands the availability of a rolling surface with the desired tyre grip. Tests on tracks made of polytetrafluoroethylene (PTFE), sprinkled with water, may give a first approximation of the behaviour of the vehicle, but do not allow for fine adjustment. Thus, extremely costly tests are needed on snow and/or on ice.

### SUMMARY OF THE INVENTION

Consequently, one aim of the present invention is to offer a method of tuning effective active safety systems without having to use rolling surfaces with low tyre grip.

Another aim of the present invention is to offer a method of tuning active safety systems in an environment with temperate, that is to say above 0° C.

Another aim of the present invention is to offer a method of tuning effective active safety systems on non-uniform surfaces such as sheets of black ice or puddles of oil.

Another aim of the present invention is to offer active safety systems that are extremely effective on rolling surfaces with low tyre grip such as snow or black ice.

Another aim of the present invention is to offer vehicles equipped with such active safety systems.

These aims are achieved, according to the present invention, with a method of tuning active safety systems employing a vehicle comprising at least one wheel equipped with a coating with low tyre grip advantageously made of a plastic material with low friction coefficient, preferably of the polytetrafluoroethylene (PTFE) type or a mixture or an alloy of PTFE with other materials.

The main subject of the invention is a method of tuning an active safety system of a motor vehicle comprising steps consisting in:

a) storing parameters in storage means;

b) testing the behaviour of a reference vehicle with said parameters stored in said storage means with tyre grip values for the tyre treads of areas on a rolling surface less than 0.6;

c) modifying the stored parameters according to the behaviour of the vehicle until a desired vehicle behaviour is obtained, characterized in that it also comprises a step;

d) of equipping the vehicle with at least one area comprising a tyre tread that has a tyre grip less than 0.6 at a temperature above 0°.

Another subject of the invention is a method that is characterized in that the step d) comprises a step d1) for fitting a ring made of a material with low friction coefficient around a tyre of an area and a step d2) for mounting said wheel on said vehicle.

Another subject of the invention is a method characterized in that the ring is made of a material comprising PTFE.

Another subject of the invention is a method characterized in that it also comprises a step e) for writing the parameters retained on completion of the step c) into a permanent memory of a computer of an active safety system.

Another subject of the invention is a method characterized in that said parameters comprise threshold values of the regulator of said active safety system.

Another subject of the invention is a method characterized in that said parameters comprise gain values of the regulator of said active safety system.

Another subject of the invention is a method characterized in that it comprises a step b) with a tyre grip less than or equal to 0.1.

Another subject of the invention is a method characterized in that, in the step d), the vehicle is equipped with four wheels, each comprising a tyre tread that has a tyre grip less than 0.6.

Another subject of the invention is an active safety system characterized in that it comprises storage means in which are stored the parameters determined by the method.

Another subject of the invention is a motor vehicle characterized in that it comprises an active safety system.

### BRIEF DESCRIPTION OF THE DRAWINGS

The present invention will be better understood from the following description and the appended figures given as nonlimiting examples and in which:

FIG. 1 is a perspective view of a coating with low tyre grip likely to cover a wheel of a motor vehicle when tuning the method according to the present invention;

FIG. 2 is a perspective view of a wheel of a motor vehicle equipped with the coating of FIG. 1;

FIG. 3 is a plan schematic view of the preferred exemplary embodiment of the coating employed by the method according to the present invention;

FIG. 4 is a flow diagram illustrating the implementation of the method according to the present invention;

FIG. 5 is a flow diagram detailing an important step of the method illustrated in FIG. 4;

FIG. 6 is a flow diagram illustrating the preferred mode of implementation of the method according to the invention.

### DETAILED DESCRIPTION

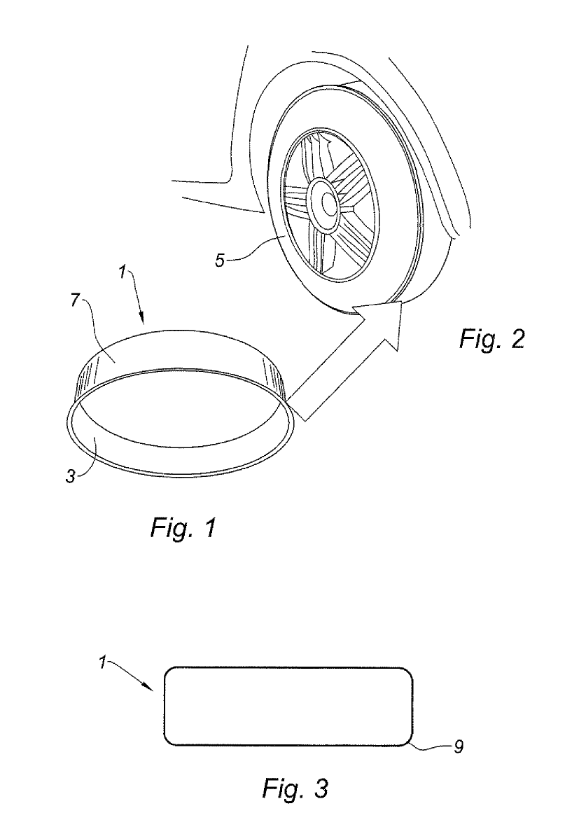

In FIGS. 1 to 6, the same references are used to denote the same elements.

FIG. 1 shows, in perspective, a ring made of a material with low friction coefficient, such as, advantageously, PTFE or a PTFE-based material, comprising a radially internal surface 3 intended to receive the tyre tread of a tyre 5 (FIG. 2) and a radially external surface 7 forming tyre tread during the tuning method according to the present invention. The ring 1 advantageously covers the entire width of the tyre 5 and may include, as illustrated in FIG. 3, rounded portions 9. The external surface 7 is advantageously smooth. The internal surface 3 is either smooth, as illustrated, or equipped with protuberances advantageously of a shape complementing the profiles of the tyre to be equipped, so as to improve the anchoring of the ring 1 on the tyre 5. The thickness of the ring 7 (that is to say the distance between the radially internal surface and the radially external surface according to a diameter of the ring 1) is sufficient to, on the one hand, confer a traction resistance that is sufficient to allow mounting around a deflated tyre then secure attachment by inflating the tyre, and, on the other hand, to withstand wear for a reasonable time corresponding to all or some of the tuning operations to be carried out. This thickness is, for example, between 1 mm and 10 cm, preferably between 3 mm and 3 cm, and even more preferably between 5 mm and 1.5 cm, for example equal to 8 mm, 10 mm or 12 mm.

Advantageously, a set of calibrated rings 1 is produced, whose tyre grip, on a reference surface, for example dry asphalt, asphalt sprinkled with water or similar, corresponds to a longitudinal tyre grip ranging from 0.5 to 0.1, in combination with transversal tyre grips ranging from 0.5 to 0.1.

Advantageously, the rings 1 are provided with markings and/or automatic identification systems such as bar codes or RFID markings to facilitate the traceability of the tests carried out during the tuning procedure according to the present invention. This marking is used to identify the ring and its characteristics.

To perform tests, the tyre 5 of a standard wheel is deflated so as to facilitate the fitting of the ring around the tyre 5 (internal surface 3 of the ring 1 facing the tyre tread of the tyre 5) and, once the ring 1 is fitted around the tyre 5, the tyre is reinflated to a pressure allowing an angular secure fixing between the tyre 5 and the ring 1. Typically, tyres are reinflated to the usual pressures or to slightly higher pressures, typically between 10⁵ Pa and 10⁶ Pa, preferably between 2 10⁵ Pa and 3.5 10⁵ Pa.

Although the wheel illustrated in FIG. 2 corresponds to the preferred exemplary embodiment, it is obvious that the use of other wheels that have a rolling surface with a tyre grip on a standard rolling surface such as asphalt of between 0.5 and 0.1 will not depart from the context of the present invention. For example, the production of tyres made of PTFE, of tyres whose tyre tread is directly made of PTFE or of solid tyres with a tyre tread made of PTFE or of a similar material will not represent a departure from the context of the present invention.

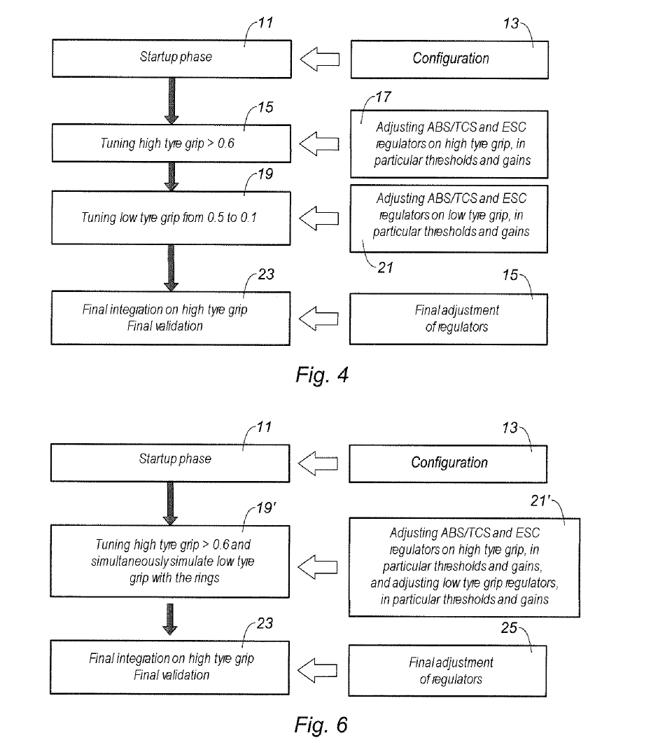

FIG. 4 shows a flow diagram illustrating the method according to the present invention. In 11, a startup phase is carried out corresponding to the configuration 13 of the tuning equipment. The phase 11 and the configuration 13 are similar to the startup phases of known-type methods.

The next step is 15. In 15, the active safety systems are tuned on high tyre grip, that is to say on a tyre grip greater than 0.6. For example, as illustrated in 17, the thresholds and gains of the regulators of the active safety systems to be tuned, such as ABS, TSC, ESC, are adjusted by using conventional tyres on a conventional surface. The step 15 is similar to the high tyre grip tuning steps of known type.

The next step is 19. In 19, at least one wheel of the vehicle for which the active safety system is being tuned is equipped with a ring 1. Typically, all four wheels of the vehicle are equipped with rings 1 for the adjustment of thresholds and gains of regulators, notably of ABS, TSC, ESC, by simulating the behaviour of the vehicle on snow and on ice by low tyre grip of the external surface 7 of the rings 1. In a first exemplary embodiment, the vehicle is equipped with a braking system provided with a standard brake fluid. In a variant, this brake fluid may be replaced with a fluid having characteristics similar to those of the brake fluid at low temperature, such as, for example, an oil with high viscosity. Thus, the presence of snow or black ice and cold are simultaneously simulated.

The method according to the present invention makes it possible to simulate rare events that are difficult to produce during tests of known type such as, for example, a tyre grip on the front wheel trains that is different from that of the rear wheel trains of the vehicle corresponding, for example, to a sheet of black ice, a tyre grip that is different on the left side of the vehicle from that on the right side of the vehicle corresponding, for example, to a start on a road with two wheels already positioned in snow whereas the other two wheels of the vehicle are still on the road or other surface. Thus, advantageously, the method according to the present invention comprises a step 19 with four wheels equipped with rings 1 then the equipping of the two in-line wheels with the rings 1 on one side and/or the other of the vehicle, equipping of the two diagonal wheels with rings 1 and the equipping of a front wheel with a ring 1 notably for traction tests for TSC systems and the equipping of a rear wheel for the creation of instability for the type of tests encountered on sheets of black ice.

The tests are advantageously repeated with various friction coefficients of the ring 1 and/or with sprinkling of the test track so as to reproduce the behaviour of the vehicle for various tyre grips between 0.5 and 0.1.

The next step is 23. The step 23 covers a final integration on high tyre grip and final validation with, as illustrated in 25, final adjustments of the regulators of the safety system.

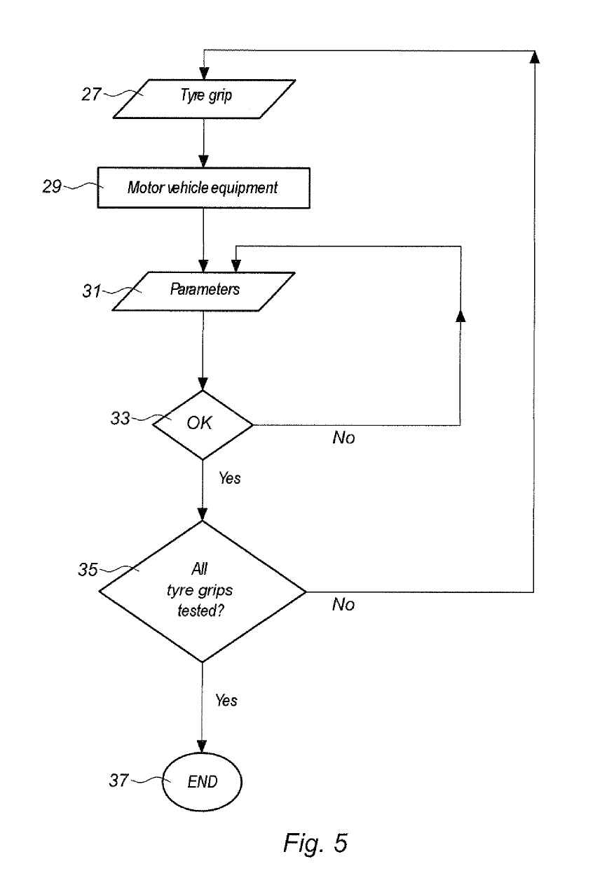

FIG. 5 shows the step 19 of FIG. 4 in more detail. In 27, the tyre grip to be tested, for example 0.5, 0.3 or 0.1, is determined. The next step is 29. In the phase 29, the vehicle is equipped accordingly, that is to say, according to the test or tests to be carried out, the vehicles are equipped with one, two, three or four wheels comprising rings whose tyre grip on the test track corresponds to that determined in 27.

The next step is 31. In 31, the applicator in charge of the tests enters parameters of the active safety system into the test system. These parameters correspond in particular to the threshold and gain of the regulators. The initial values correspond, for example, to the values retained for a similar vehicle previously tuned.

The next step is 33. In 33, the applicator drives the vehicles in normal conditions and extreme conditions so as to check the correct behaviour of the vehicle equipped with the active safety system according to the present invention. If the system behaves in a manner that conforms to the specifications with regard to safety and/or comfort, the method goes on to step 35. Otherwise, the method returns to 31. In 31, the applicator modifies the parameters, notably the thresholds and gains of the regulators, according to the behaviour of the vehicle during the preceding test or tests 33.

If yes, the step 19 is terminated at 37. In 35, a check is carried out to ensure that all the configurations, notably all the tyre grips, have been tested, otherwise the method returns to 27. In 27, the tests are begun for another configuration, for example, another tyre grip or another arrangement of the wheels equipped with rings 1.

In the example of FIG. 4, the step 15 is separate from the step 19 by analogy with the known-type tuning method. However, it may prove advantageous, as illustrated in FIG. 6, to combine the steps 15 and 19 in a single step 19′, during which the tuning of all the tyre grips is performed with, as illustrated in 21′, the adjustment of all the parameters, notably the threshold and gain of the regulators. The tests are thus accelerated according to the availabilities of the applicators and of the vehicle prototypes to be tuned and of the test rigs.

The parameters determined in 31/19 and validated in 23, notably the regulator threshold and gain adjustment, are stored in the permanent program memory of the computer of the active safety system intended for the production-line vehicles whose assembly is handled by the motor vehicle manufacturer. A permanent memory of the read-only memory (ROM), programmable read-only memory (PROM), erasable programmable read-only memory (EPROM), electrically erasable programmable read-only memory (EEPROM) and/or flash EEPROM type is used.

The present invention applies notably to the motor vehicle industry.

The present invention applies mainly to the active safety system industry.

### REFERENCES

Ring: 1

Internal surface: 3

Tyre: 5

External surface: 7

Rounded edge 9

Startup phase: 11

Configuration: 13

Tuning high tyre grip: 15

Adjustment of regulators: 17

Tuning low tyre grip: 19

Adjustment of regulators: 21

Integration and validation: 23

Adjustment of regulators: 25

Choice of tyre grip: 27

Vehicle equipment: 29

Choice and/or storage of parameters 31

Checking conformity of 33

vehicle behaviour with

desired behaviour

Checking exhaustiveness of tests 35

End 37

1. A method of tuning an active safety system of a motor vehicle, the method comprising:
a) storing parameters in storage means;
b) testing the behaviour of a reference vehicle with said parameters stored in said storage means with tyre grip values for the tyre treads of areas on a rolling surface less than 0.6; and
c) modifying the stored parameters according to the behaviour of the vehicle until a desired vehicle behaviour is obtained,
d) wherein modifying the stored parameters includes equipping the vehicle with at least one area comprising a tyre tread (7) that has a tyre grip less than 0.6 at a temperature above 0° C.

2. The method according to claim 1, further characterized in that the step d) comprises a step dl) for fitting a ring (1) made of a material with low friction coefficient around a tyre (5) of an area and a step d2) for mounting said wheel on said vehicle.

3. The method according to claim 2, wherein the ring (1) is made of a material comprising PTFE.

4. The method according to claim 1, further characterized in that it also comprises a step e) for writing the parameters retained on completion of the step c) into a permanent memory of a computer of an active safety system.

5. The method according to claim 1, wherein the said parameters comprise threshold values of a regulator of said active safety system.

6. The method according to claim 1, wherein the said parameters comprise gain values of the regulator of said active safety system.

7. The method according to claim 1, further characterized in that it comprises a step b) with a tyre grip less than or equal to 0.1.

8. The method according to claim 1, further characterized in that, in the step d), the vehicle is equipped with four wheels, each comprising a tyre tread that has a tyre grip less than 0.6.

9. (canceled)

10. (canceled)

11. An active safety system of a motor vehicle, the system comprising:
a computer; and
a storage means connected to the computer and configured to store parameters; and
a test system configured to test the behaviour of a reference vehicle with said parameters with tyre grip values for the tyre treads of areas on a rolling surface less than 0.6,
wherein the safety system is configured to modify the stored parameters according to the behaviour of the vehicle until a desired vehicle behaviour is obtained.

12. The active safety system of claim 1, wherein the safety system is configured to equip the vehicle with at least one area comprising a tyre tread (7) that has a tyre grip less than 0.6 at a temperature above 0° C.
